(19) United States
(12) Patent Application Publication
(10) Pub. No.: US 2004/0030931 A1
(43) Pub. Date: Feb. 12, 2004

(54) System and method for providing enhanced network security

(76) Inventors: Alexander G. Chamandy, Arlington, VA (US); Sean P. Davis, Centreville, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/638,313

(22) Filed: Aug. 12, 2003

Related U.S. Application Data
(60) Provisional application No. 60/319,463, filed on Aug. 12, 2002.

(51) Int. Cl. G06F 11/30; G06F 15/173

(52) U.S. Cl. 713/201; 709/224

(57) ABSTRACT

A system and method for providing enhance network security is disclosed. In particular, data traffic is initially presented to a network device for processing. In response, the device reviews the data traffic and compares the data traffic against predetermined criteria. Next, it is determined whether the data traffic matches the criteria and, if so, a handler script is called to process the data traffic in accordance with its identification. If the data traffic does not match the criteria, the process ends and the data traffic is passed as conventional traffic. Because information regarding the data traffic is initially reviewed passively, the process of the present invention is able to operate using very little in the way of processor resources. Only when traffic identification information is passed to the handler script is an action actually performed on the traffic. Additionally, by providing a handler script outside the confines of the traffic analyzing program, changes to the handling of identified traffic may be modified without requiring a recompilation of the entire system.

### CROSS-REFERENCE TO RELATED APPLICATIONS

The following application claims the benefit of co-pending U.S. Provisional Patent Application No. 60/319,463 filed Aug. 12, 2002, the entirety of which is incorporated by reference herein.

### BACKGROUND OF THE INVENTION

The present invention relates generally to computer networks and, more particularly, to systems and methods for protecting such networks from attacks by unauthorized parties.

With the proliferation of computer networks reaching heretofore unanticipated levels, security on these networks is becoming more crucial to the operation of a wide variety of disparate organizations. Unfortunately, as the computer networks employed by these organizations continue to grow in both complexity and size, managing security becomes an increasingly difficult task. Adding to that, as more and more information is maintained on these networks, malicious attacks on computer networks also continue to grow. Additionally, due to the ever-changing nature and identifiable symptoms of these attacks, conventional network administrators are typically unable to quickly identify and rebuff all potential attacks.

Computer network attacks can take many forms and result in many different types of damage, such as theft of confidential or private information; implanting viruses, worms or Trojan horses on the network thereby causing deleterious effects; and overwhelming a network's capabilities, thereby causing a denial of service. Details regarding several types of network attacks are described in further detail below.

Traditionally, the first line of defense against most security attacks is to attempt to restrict access to network resources through the use of authentication or filtering systems, such as a passwords, firewalls, and the like. Unfortunately, firewalls and other authentication systems can be circumvented using many known techniques, and are therefore insufficient alone to provide the level of security required in many computer networks. One known method for circumventing a firewall is known as IP spoofing, wherein unauthorized individuals adopt the internet protocol address of legitimate network users. Network attackers may utilize many techniques to learn information about network users (such as IP addresses) and use this information to obtain unauthorized access to a network. For example, in the UNIX™ operating system, the ‘finger’ tool is a feature that allows authorized local users to locate other users on the network. Similarly, a ‘netstat’ tool is available that enables users to obtain information regarding the status of the network. Unauthorized attackers may use these system tools to gather information about valid users (such as IP addresses) and subsequently use that information to gain unauthorized access to the network, by tricking the firewall into treating the unauthorized user is an authorized user. Additionally, network attackers may use other programs stored on the network to gain unauthorized access to a network. For example, programs like sendmail and X-windows™ are programs that may allow access to program libraries or otherwise release information about authorized network users.

Another method used by attackers to gain access to a network is through typically dormant computer programs known as daemons. In general, daemons are intended to provide useful services that is not explicitly invoked but rather respond to network or system conditions. In this manner, the daemons may be invoked without any explicit action on the part of the user. For example, hypertext transfer protocol daemons (HTTPd) and file transfer protocol daemons (FTPd) are programs used to provide information for the world wide web or other networks. Unfortunately, absent proper configuration, network paths through an HTTPd or FTPd may also enable unauthorized attackers to gain access to the network through the firewall.

In addition to merely circumventing a firewall, a network may also be attacked by overwhelming the network security in place or the overall network resources resulting in a loss or reduction of network capabilities. Such methods for reducing network capabilities are generally referred to as denial of service (DoS) attacks. Examples of known techniques used in DoS attacks include UDP bombs, ping floods, SYN floods and the teardrop and land attack. The result of many of these attacks is the flooding of system resources with a large number of concurrent access requests. Although the firewall generally operates correctly to deny access, one of the unintended consequences of such security systems is that the very act of repelling a large scale attack may lead to such a large number of trouble messages which then overwhelm the network and lead to denial of service simply by the volume of messages.

In addition to network attacks directed toward a specific network device or node, a large network is likely to be attacked by various concurrent, relatively simple attacks on multiple network nodes or from multiple sources, with the hope that the aggregation of attacks may cause the intended damage. Additionally, many conventional systems report perceived network attacks in real-time to network administrators for instructions on how to handle the attack. In these circumstances, the sheer number of attacks may overwhelm network personnel.

Conventional systems for identifying network security attacks, generally fall into three areas: network modelers, static analyzers and testers, and dynamic analyzers. Network modeling systems are designed to enable network developers to create a virtual model of the network and test it for security concerns prior to actual implementation or update. Additionally, network modelers also enable network developers to determine the potential effects of successful attacks. Using such systems, network administrators can better estimate the robustness of the network design and potential responses to security attacks. Unfortunately, because network modelers base their analysis on known information, they are often traditionally unable to a accurately predict network security flaws in light of unknown attack scenarios. Additionally, network modelers do not provide any real-time monitoring functions, thereby failing to protect against actual attacks.

Similar to network modeler systems, static analyzer systems may also be used to simulate an attack against the organization's own network. In this manner, static analyzers can probe for network weaknesses by simulating certain types of attacks or attack combinations, such as password vulnerability, virus susceptibility, and the like. Unfortunately, these systems either test the integrity of the network, or identify a security event after it has occurred. As with network modeler systems, static analyzers fail to protect against actual attacks in real-time.

Unlike network modelers and static analyzers, dynamic analyzer systems are used to monitor networks and respond at the time of the attack. Dynamic analyzers typically monitor the computer network and identify specific actions that comprise known symptoms of attack or compare user actions to previously stored statistics to identify significant changes.

Correspondingly, these systems also generally offer real-time notification of perceived attacks to network administrators. Unfortunately, this real-time reporting feature may potentially lead to significant problems for network capacity, in circumstances where the number of perceived attacks large enough that reporting of the events utilizes virtually all available bandwidth on the network. Additionally, known dynamic analyzers traditionally monitor network activity only on a node by node basis. For simultaneous attacks on multiple network nodes or repeated attacks on different nodes, known systems are unable to see across nodes, thereby rendering them blind to prior or contemporaneous occurrences at different nodes.

In addition to the known problems with conventional network security systems, many such systems are also designed to provide protection for computer networks implementing specific platforms or computing environments. Consequently, implementing a continuous security system across a multitude of platforms is often outside the scope of the existing system.

Accordingly, there is a need in the art of computer network security for a system and method for adaptively providing network security in a real-time manner. Additionally, there is a further need for a system and method for providing such network security by utilizing information collected across a variety of network nodes. Further, there is a need for a network security system which may be simultaneously implemented across several diverse computing platforms.

### BRIEF SUMMARY OF THE INVENTION

The present invention overcomes the above-described problems and deficiencies by providing a system and method for providing enhance network security. In particular, data traffic is initially presented to a network device for processing. In response, the device reviews the data traffic and compares the data traffic against predetermined criteria. Next, it is determined whether the data traffic matches the criteria and, if so, a handler script is called to process the data traffic in accordance with its identification. If the data traffic does not match the criteria, the process ends and the data traffic is passed as conventional traffic. Because information regarding the data traffic is initially reviewed passively, the process of the present invention is able to operate using very little in the way of processor resources. Only when traffic identification information is passed to the handler script is an action actually performed on the traffic. Additionally, by providing a handler script outside the confines of the traffic analyzing program, changes to the handling of identified traffic may be modified without requiring a recompilation of the entire system.

### BRIEF DESCRIPTION OF THE DRAWINGS

The present invention can be understood more completely by reading the following Detailed Description of the Preferred Embodiments, in conjunction with the following drawings.

FIG. 1 is one embodiment of a computer network 100 for use with the network security system of the present invention.

FIG. 2 is a flow diagram illustrating a method for providing enhanced network security in accordance with one embodiment of the present invention.

FIG. 3 is a flow diagram illustrating a more specific embodiment of the method described generally in FIG. 2 and relating specifically to a method for blocking data traffic based upon identification of its IP address.

FIG. 4 is a flow diagram illustrating a more detailed embodiment of step 300 described in FIG. 3 and relating to reading configuration data into the network device's processor.

FIG. 5 is a flow diagram illustrating a more detailed embodiment of steps 304-308 described in FIG. 3 and relating to the steps of analyzing the IP address log file, parsing the new entries from the log and comparing the new entries against loaded configuration data and saved IP address data.

FIG. 6 is a flow diagram illustrating one embodiment of a method for maintaining and checking the content of the linked list of IP addresses.

### DETAILED DESCRIPTION OF THE PREFERRED EMBODIMENTS

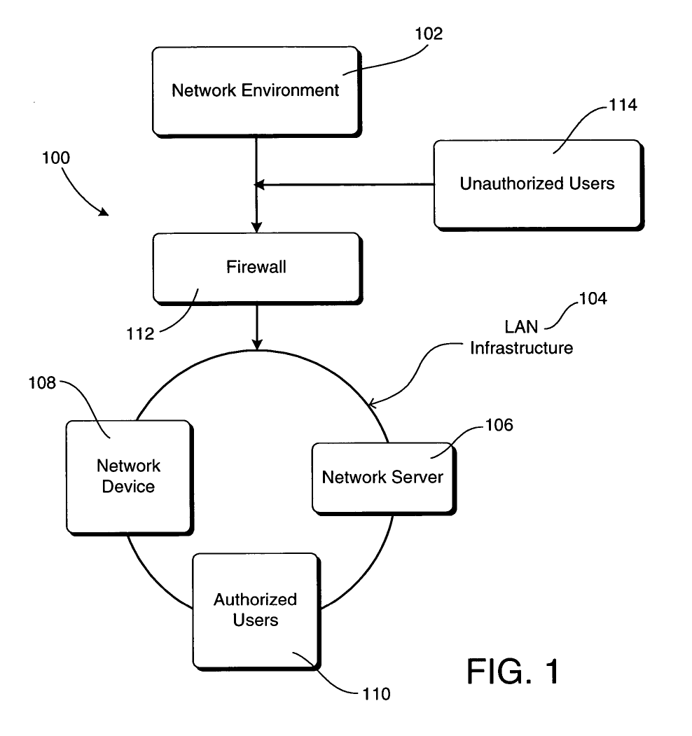

Referring generally to figures and, in particular, to FIG. 1, there is illustrated one embodiment of a computer network 100 for use with the network security system of the present invention. In particular, the illustrated network 100 includes several exemplary components, including a local network environment 102, a local area network (LAN) infrastructure 104, a local network server 106, a network device 108, a plurality of authorized users 110, and a firewall 112 for screening network access from unauthorized external users 114. The local network environment 102 typically includes connections to external network components, such as an Internet service provider or system routers for connecting to remote locations and forming a wide area network (WAN). Further, administrators for network 100 utilize the firewall 112 to create a secure environment by theoretically isolating the network 100 from external intrusion. It should be understood that firewall 112 may be implemented as either a discrete hardware component or as software running on another network component. In general, computer networks utilize firewall 112 as a first line of defense against a network attack. Unfortunately, as described above, firewalls can be circumvented using many techniques, (e.g., IP spoofing, etc.) and are therefore insufficient alone to provide the level of security required in many computer networks.

The system and method of the present invention operate to provide enhanced security on the network 100 by enabling the examination of network information and subsequently responding to the information examined in real-time to protect the network from attack. As will be set forth in detail below, in an extremely efficient and processor-conservative manner, the present invention enables blocking or other actions to be performed against identified traffic in real-time without requiring case-by-case interaction on the part of network administrators. In this manner, the network is protected without undue performance degradation resulting in denial of service to authorized users. In a preferred embodiment, the system and method of the present invention are embodied as software instructions stored on a medium readable by a processor associated with a network device. In one embodiment, these instructions may be written in the C++ software language, although any suitable software language may be utilized and implemented.

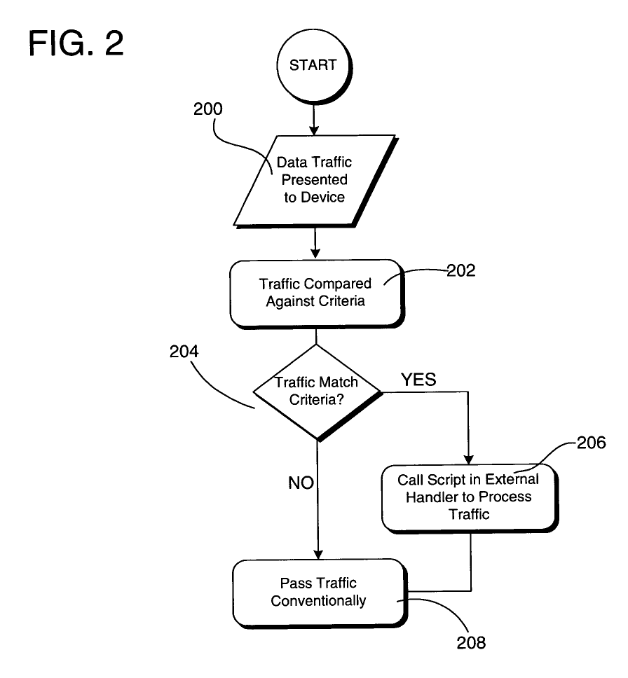

Referring now to FIG. 2, there is shown a flow diagram illustrating a method for providing enhanced network security in accordance with one embodiment of the present invention. In step 200, data traffic is presented to a network device for processing. In response, the device, in step 202, reviews the data traffic and compares the data traffic against predetermined criteria. In step 204, it is determined whether the data traffic matches the criteria and, if so, a handler script is called to process the data traffic in accordance with its identification in step 206. If the data traffic does not match the criteria, the process ends and the data traffic is passed as conventional traffic in step 208. Because information regarding the data traffic is initially reviewed passively, the process of the present invention is able to operate using very little in the way of processor resources. Only when traffic identification information is passed to the handler script in step 206 is an action actually performed on the traffic. Additionally, by providing a handler script outside the confines of the traffic analyzing program, changes to the handling of identified traffic may be modified without requiring a recompilation of the entire system. This feature greatly enhances the simplicity and ease of implementation of the present invention.

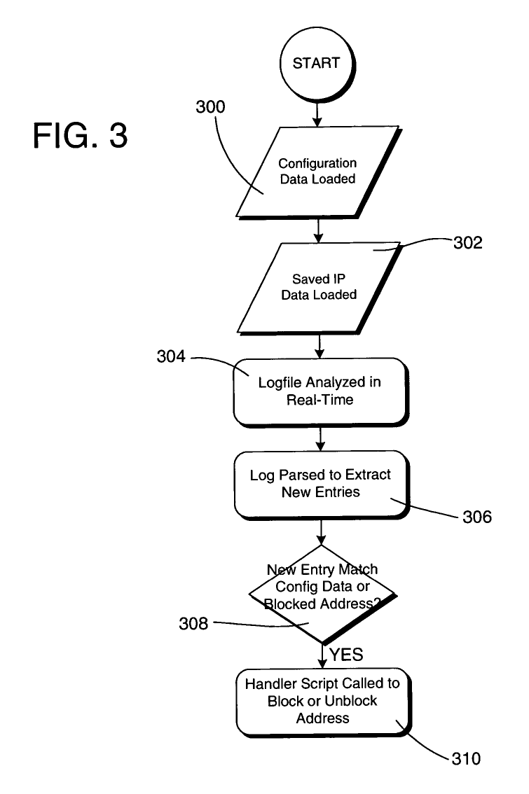

Referring now to FIG. 3, there is shown a flow diagram illustrating a more specific embodiment of the method described generally in FIG. 2 and relating specifically to a method for blocking data traffic based upon identification of its IP address. In particular, in step 300, predetermined configuration data is loaded into the processor of a network device. This is typically performed at the execution or restarting of the program binary or system reboot and relates specifically to the manner in which data traffic information is loaded and reviewed. Next, in step 302, IP address data which was saved prior to the last exit of the system is read into a linked list file within the processor. In a preferred embodiment, IP address data includes at least the following information: IP ADDRESS; a COUNT value representative of the number of times the address has been identified; a TIME value representing the time that the IP address was added; a BLOCKED value indicating whether the identified address has been blocked; and a BTIME value representing the time the address was blocked. The saved information relates to IP addresses which had formerly been either blocked or unblocked and may be used to identify suspicious IP addresses or activity in received data traffic.

Following loading of saved IP information, a log of data traffic activity is analyzed in real-time in step 304. In one embodiment, this log is simply a flat file created and continually updated by the network device upon receipt of data traffic. At a predetermined interval, the log is parsed in step 306 and any new entries are read and compared to the loaded configuration data and saved IP address data in step 308. If the new traffic meets the criteria established in the configuration data or if it matches a previously blocked IP address, a handler script is called in step 310 which operates to either block or unblock the address. By providing a simple and efficient means for analyzing network traffic and blocking traffic from suspicious IP addresses without direct administrator input, the system of the present invention enables the enhanced protection of the network upon which the network device resides.

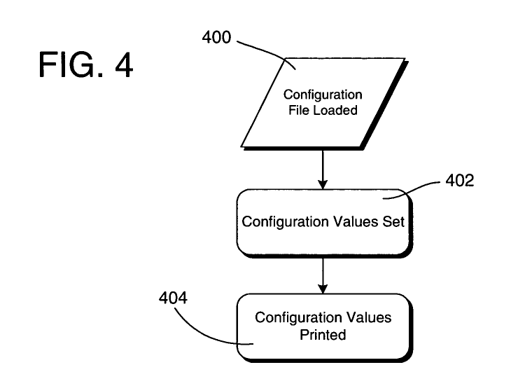

Referring now to FIG. 4, there is shown a flow diagram illustrating a more detailed embodiment of step 300 described in FIG. 3 above, relating to reading configuration data into the network device's processor. In step 400, the configuration file is read into system memory. Next, in step 402, a plurality of configuration values are set based upon the read configuration file. In a preferred embodiment, read configuration values may include the following values: a LOGFILE value relating to the path to the watched log file; a SAVEFILE value relating to the path to the save file; a SCRIPT value relating to the path to the external script used to block/unblock addresses; a MAXAGE value defining the maximum age of an IP address block; a MAXCOUNT value defining the number of failures from an IP address which result in blockage; a BLOCKTIME value relating to the duration of an IP address block; and a TIMEVAL delay value relating to a delay between successive checks of the log file. In step 404, once all configuration values have been read, the values are printed to an output log.

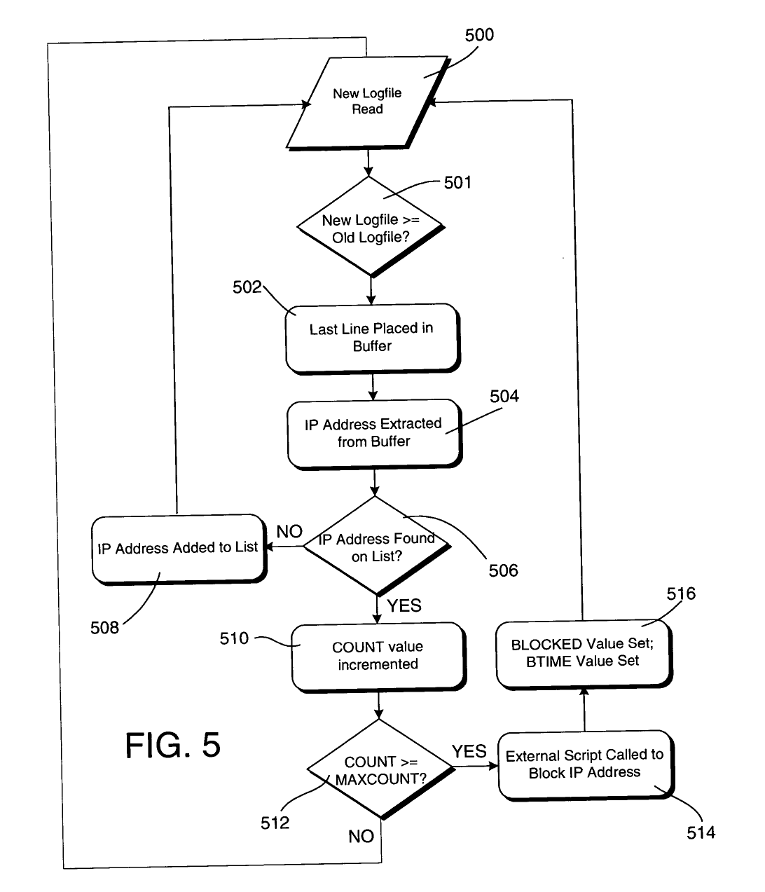

Referring now to FIG. 5, there is shown a flow diagram illustrating a more detailed embodiment of steps 304-308 described in FIG. 3 above, relating to the steps of analyzing the IP address log file, parsing the new entries from the log and comparing the new entries against loaded configuration data and saved IP address data. In step 500, a new log file is read in. Next, in step 501, the size of the new log file is compared against the size of the previously analyzed log file. If the new log file is larger than the previous log file, the last line of the log file is placed into a buffer in step 502. In step 504, the contents of the buffer are examined and the IP address is extracted.

Next, in step 506, the linked list of previously saved IP addresses is searched for the currently extracted IP address. If it is not found in the list, the IP address information is added to the list in step 508 including each element specifically set forth above, including the time of its listing, the address, etc. However, if the IP address is found in the list, the COUNT value associated with the saved information for the identified IP address is incremented by one in step 510 and the resulting value is compared to the MAXCOUNT value read in during the configuration process in step 512. If the COUNT value is greater than or equal to the MAXCOUNT value, the external script is called to block the identified IP address in step 514. In addition, in step 516, the BLOCKED value for the identified IP address is set to indicate that the address is blocked and the BTIME value is set to indicate the time at which the block was initiated. Following execution, the process then returns to step 500 and, following the configured time interval, the new log file is read and the process begins again.

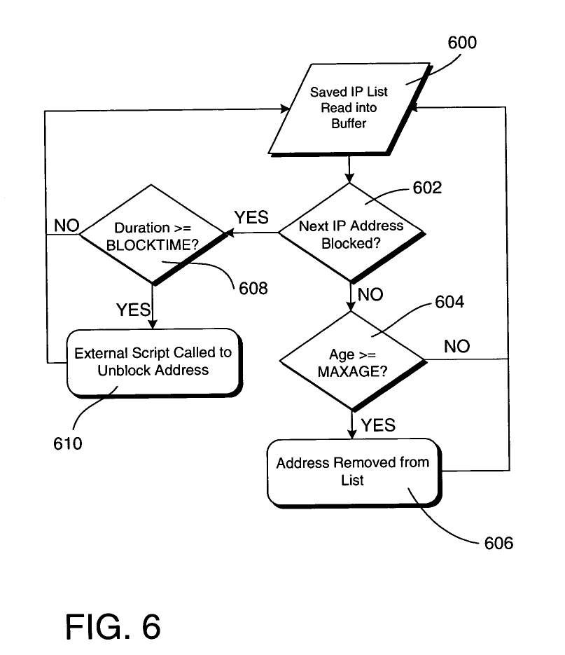

Referring now to FIG. 6, there is shown a flow diagram illustrating one embodiment of a method for maintaining and checking the content of the linked list of IP addresses described above. In a preferred embodiment, the process described below may be performed contemporaneously during the reading of the next log file in step 500 above, although any suitable alternative mode of operation is also envisioned. In step 600, the current linked list of IP addresses is read into a buffer. Next, in step 602, the next listed IP address (or the first if the process has just started) is checked to determine whether it is currently blocked. If not, in step 604, the age of the IP addresses entry is compared with the MAXAGE value read in during configuration. The age of the entry is easily determined by subtracting the entry's TIME value from the current time of the check. If the entry's age is greater equal to MAXAGE, the IP address is removed from the list in step 606.

If the IP address has been blocked, the duration of the block is compared against the BLOCKTIME value read in during configuration in step 608. As with an entry's age, a block's duration is easily calculated by subtracting the entry's BTIME value from the current time of the check. If the duration is greater than or equal to BLOCKTIME, the external script handler is called in step 610 to unblock the identified IP address and permit traffic from the address to flow through the network device.

By providing a simple and effective means for clearing expired IP address entries from the list of entries and removing address blockages, the system of the present invention easily manages dynamic modification of identified addresses, thereby preventing the system from bogging down in searching through a limitless number of addresses.

In a preferred application, the external script described above may be written in a computer software language such as PERL (Practical Extraction and Report Language). By providing an external script for performing the actual blocking and unblocking of IP addresses from network traffic, the manner in which this is performed is rendered easily modifiable and changes do not require recompilation of the underlying code for the overall system. In this manner, the present invention may be easily ported to various different operating platforms and environments with little effort required to modify the application. Rather, PERL scripts configured for the various operating environments may be easily generated to effect the desired blocking and unblocking actions.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for providing enhance network security, comprising:
receiving data traffic at a network device for processing;
reviewing the data traffic and comparing the data traffic against predetermined criteria;
determining whether the data traffic matches the criteria;
calling an external handler script to process the data traffic if it is determined that the data traffic matches the criteria; and
passing the data traffic as conventional traffic if it is determined that the data traffic does not match the criteria.

2. The method of claim 1, further comprising:
loading predetermined configuration data into a processor of the network device, wherein configuration data includes the predetermined criteria;
reading stored IP address data into a linked list file within the processor, wherein the stored IP address data represents information regarding previously analyzed IP addresses;
generating a log of data traffic in substantially real-time;
analyzing the log of data traffic in substantially real-time;
parsing the log of data traffic at predetermined intervals to extract new entries;
comparing the extracted new entries to the stored IP address data and the configuration data; and
calling the external handler script to process the data traffic if it is determined that the data traffic matches the criteria.

3. The method of claim 2, wherein the predetermined criteria includes criteria for blocking and unblocking network access to an IP address and further comprising:
calling the external handler script to block or unblock the data traffic if it is determined that the data traffic matches a previously blocked IP address from the stored IP address data.

4. The method of claim 2, further comprising:
storing IP ADDRESS data for the received data traffic in the stored IP address data;
storing a COUNT value data in the stored IP address data representative of the number of times the address has been identified;
storing a TIME value data in the stored IP address data representing the time that the IP address was added;
storing a BLOCKED value data in the stored IP address data indicating whether the identified address has been blocked; and
storing a BTIME value data in the stored IP address data representing the time the address was blocked.

5. The method of claim 2, wherein loading predetermined configuration data into a processor of the network device further comprises:
loading a configuration file into system memory of the network device;
setting a plurality of configuration values based upon the configuration file; and
printing the configuration values to an output log.

6. The method of claim 5, wherein setting a plurality of configuration values further comprises:
setting a LOGFILE value relating to the path to the watched log file;
setting a SAVEFILE value relating to the path to the save file;
setting a SCRIPT value relating to the path to the external script used to block/unblock addresses;
setting a MAXAGE value defining the maximum age of an IP address block;
setting a MAXCOUNT value defining the number of failures from an IP address which result in blockage;
setting a BLOCKTIME value relating to the duration of an IP address block; and
setting a TIMEVAL delay value relating to a delay between successive checks of the log file.

7. The method of claim 2, further comprising:
reading a new log file into system memory of the network device;
comparing a size of the new log file against a size of the previously analyzed log file;
placing the last line of the new log file is placed into a buffer if the new log file is larger than the previous log file;
examining the contents of the buffer;
extracting the IP address from the contents of the buffer;
searching the stored IP address data for the currently extracted IP address;
adding the IP address information to the stored IP address data, if the currently extracted IP address is not found in the stored IP address data;
incrementing a COUNT value associated with the matching stored IP address if the currently extracted IP address is found in the stored IP address data;
comparing the incremented COUNT value to a MAXCOUNT value read in during the configuration; and
calling the external handler script to block the identified IP address if the COUNT value is greater than or equal to the MAXCOUNT value.

8. The method of claim 7, further comprising:
setting a BLOCKED value for the identified IP address to indicate that the address is blocked; and
setting a BTIME for the identified IP address value to indicate the time at which the block was initiated.

9. The method of claim 8, further comprising:
reading the stored IP address data into a buffer;
determining whether an IP address entry is currently blocked;
performing the following steps if it is determined that the IP address entry is not currently blocked:
comparing an age of the IP addresses entry with a MAXAGE value read in during configuration;
removing the IP address entry from the stored IP address data if the entry's age is greater equal to MAXAGE;
performing the following steps if it is determined that the IP address entry is currently blocked:
comparing the duration of the block is compared against the BLOCKTIME value read in during configuration; and
calling the external handler script to unblock the identified IP address entry and permit traffic from the address to flow through the network device if the duration is greater than or equal to BLOCKTIME.

10. The method of claim 9, further comprising
storing a TIME value data in the stored IP address data representing the time that the IP address was added;
storing a BTIME value data in the stored IP address data representing the time the address was blocked.
determining the age of an IP address entry by subtracting the entry's TIME value from the current time of the check; and
determining a block's duration by subtracting the entry's BTIME value from the current time of the check.

11. A system for providing enhance network security, comprising:
means for receiving data traffic at a network device for processing;
means for reviewing the data traffic and comparing the data traffic against predetermined criteria;
means for determining whether the data traffic matches the criteria;
means for calling an external handler script to process the data traffic if it is determined that the data traffic matches the criteria; and
means for passing the data traffic as conventional traffic if it is determined that the data traffic does not match the criteria.

12. The system of claim 11, further comprising:
means for loading predetermined configuration data into a processor of the network device, wherein configuration data includes the predetermined criteria;
means for reading stored IP address data into a linked list file within the processor, wherein the stored IP address data represents information regarding previously analyzed IP addresses;
means for generating a log of data traffic in substantially real-time;
means for analyzing the log of data traffic in substantially real-time;
means for parsing the log of data traffic at predetermined intervals to extract new entries;
means for comparing the extracted new entries to the stored IP address data and the configuration data; and
means for calling the external handler script to process the data traffic if it is determined that the data traffic matches the criteria.

13. The system of claim 12, wherein the predetermined criteria includes criteria for blocking and unblocking network access to an IP address and further comprising:
means for calling the external handler script to block or unblock the data traffic if it is determined that the data traffic matches a previously blocked IP address from the stored IP address data.

14. The system of claim 12, further comprising:
means for storing IP ADDRESS data for the received data traffic in the stored IP address data;
means for storing a COUNT value data in the stored IP address data representative of the number of times the address has been identified;
means for storing a TIME value data in the stored IP address data representing the time that the IP address was added;
means for storing a BLOCKED value data in the stored IP address data indicating whether the identified address has been blocked; and
means for storing a BTIME value data in the stored IP address data representing the time the address was blocked.

15. The system of claim 12, wherein the means for loading predetermined configuration data into a processor of the network device further comprise:
means for loading a configuration file into system memory of the network device;
means for setting a plurality of configuration values based upon the configuration file; and
means for printing the configuration values to an output log.

16. The system of claim 15, wherein the means for setting a plurality of configuration values further comprise:
means for setting a LOGFILE value relating to the path to the watched log file;
means for setting a SAVEFILE value relating to the path to the save file;
means for setting a SCRIPT value relating to the path to the external script used to block/unblock addresses;
means for setting a MAXAGE value defining the maximum age of an IP address block;
means for setting a MAXCOUNT value defining the number of failures from an IP address which result in blockage;
means for setting a BLOCKTIME value relating to the duration of an IP address block; and
means for setting a TIMEVAL delay value relating to a delay between successive checks of the log file.

17. The system of claim 12, further comprising:
means for reading a new log file into system memory of the network device;
means for comparing a size of the new log file against a size of the previously analyzed log file;
means for placing the last line of the new log file is placed into a buffer if the new log file is larger than the previous log file;
means for examining the contents of the buffer;
means for extracting the IP address from the contents of the buffer;
means for searching the stored IP address data for the currently extracted IP address;
means for adding the IP address information to the stored IP address data, if the currently extracted IP address is not found in the stored IP address data;
means for incrementing a COUNT value associated with the matching stored IP address if the currently extracted IP address is found in the stored IP address data;
means for comparing the incremented COUNT value to a MAXCOUNT value read in during the configuration; and
means for calling the external handler script to block the identified IP address if the COUNT value is greater than or equal to the MAXCOUNT value.

18. The system of claim 17, further comprising:
means for setting a BLOCKED value for the identified IP address to indicate that the address is blocked; and
means for setting a BTIME for the identified IP address value to indicate the time at which the block was initiated.

19. The system of claim 18, further comprising:
means for reading the stored IP address data into a buffer;
means for determining whether an IP address entry is currently blocked;
means for performing the following steps if it is determined that the IP address entry is not currently blocked:
comparing an age of the IP addresses entry with a MAXAGE value read in during configuration;
removing the IP address entry from the stored IP address data if the entry's age is greater equal to MAXAGE;
means for performing the following steps if it is determined that the IP address entry is currently blocked:
comparing the duration of the block is compared against the BLOCKTIME value read in during configuration; and
calling the external handler script to unblock the identified IP address entry and permit traffic from the address to flow through the network device if the duration is greater than or equal to BLOCKTIME.

20. The system of claim 19, further comprising
means for storing a TIME value data in the stored IP address data representing the time that the IP address was added;
means for storing a BTIME value data in the stored IP address data representing the time the address was blocked.
means for determining the age of an IP address entry by subtracting the entry's TIME value from the current time of the check; and
means for determining a block's duration by subtracting the entry's BTIME value from the current time of the check.

21. A computer-readable medium incorporating one or more instructions for providing enhance network security, the instructions comprising:
one or more instructions for receiving data traffic at a network device for processing;
one or more instructions for reviewing the data traffic and comparing the data traffic against predetermined criteria;
one or more instructions for determining whether the data traffic matches the criteria;
one or more instructions for calling an external handler script to process the data traffic if it is determined that the data traffic matches the criteria; and
one or more instructions for passing the data traffic as conventional traffic if it is determined that the data traffic does not match the criteria.

22. The computer-readable medium of claim 11, further comprising:
one or more instructions for loading predetermined configuration data into a processor of the network device, wherein configuration data includes the predetermined criteria;
one or more instructions for reading stored IP address data into a linked list file within the processor, wherein the stored IP address data represents information regarding previously analyzed IP addresses;
one or more instructions for generating a log of data traffic in substantially real-time;
one or more instructions for analyzing the log of data traffic in substantially real-time;
one or more instructions for parsing the log of data traffic at predetermined intervals to extract new entries;
one or more instructions for comparing the extracted new entries to the stored IP address data and the configuration data; and
one or more instructions for calling the external handler script to process the data traffic if it is determined that the data traffic matches the criteria.

23. The computer-readable medium of claim 12, wherein the predetermined criteria includes criteria for blocking and unblocking network access to an IP address and further comprising:
one or more instructions for calling the external handler script to block or unblock the data traffic if it is determined that the data traffic matches a previously blocked IP address from the stored IP address data.

24. The computer-readable medium of claim 12, further comprising:
one or more instructions for storing IP ADDRESS data for the received data traffic in the stored IP address data;
one or more instructions for storing a COUNT value data in the stored IP address data representative of the number of times the address has been identified;
one or more instructions for storing a TIME value data in the stored IP address data representing the time that the IP address was added;
one or more instructions for storing a BLOCKED value data in the stored IP address data indicating whether the identified address has been blocked; and
one or more instructions for storing a BTIME value data in the stored IP address data representing the time the address was blocked.

25. The computer-readable medium of claim 12, wherein the one or more instructions for loading predetermined configuration data into a processor of the network device further comprise:
one or more instructions for loading a configuration file into system memory of the network device;
one or more instructions for setting a plurality of configuration values based upon the configuration file; and
one or more instructions for printing the configuration values to an output log.

26. The computer-readable medium of claim 15, wherein the one or more instructions for setting a plurality of configuration values further comprise:
one or more instructions for setting a LOGFILE value relating to the path to the watched log file;
one or more instructions for setting a SAVEFILE value relating to the path to the save file;
one or more instructions for setting a SCRIPT value relating to the path to the external script used to block/unblock addresses;
one or more instructions for setting a MAXAGE value defining the maximum age of an IP address block;
one or more instructions for setting a MAXCOUNT value defining the number of failures from an IP address which result in blockage;
one or more instructions for setting a BLOCKTIME value relating to the duration of an IP address block; and
one or more instructions for setting a TIMEVAL delay value relating to a delay between successive checks of the log file.

27. The computer-readable medium of claim 12, further comprising:
one or more instructions for reading a new log file into system memory of the network device;
one or more instructions for comparing a size of the new log file against a size of the previously analyzed log file;
one or more instructions for placing the last line of the new log file is placed into a buffer if the new log file is larger than the previous log file;
one or more instructions for examining the contents of the buffer;
one or more instructions for extracting the IP address from the contents of the buffer;
one or more instructions for searching the stored IP address data for the currently extracted IP address;
one or more instructions for adding the IP address information to the stored IP address data, if the currently extracted IP address is not found in the stored IP address data;
one or more instructions for incrementing a COUNT value associated with the matching stored IP address if the currently extracted IP address is found in the stored IP address data;
one or more instructions for comparing the incremented COUNT value to a MAXCOUNT value read in during the configuration; and
one or more instructions for calling the external handler script to block the identified IP address if the COUNT value is greater than or equal to the MAXCOUNT value.

28. The computer-readable medium of claim 17, further comprising:
one or more instructions for setting a BLOCKED value for the identified IP address to indicate that the address is blocked; and
one or more instructions for setting a BTIME for the identified IP address value to indicate the time at which the block was initiated.

29. The computer-readable medium of claim 18, further comprising:
one or more instructions for reading the stored IP address data into a buffer;
one or more instructions for determining whether an IP address entry is currently blocked;
one or more instructions for performing the following steps if it is determined that the IP address entry is not currently blocked:
comparing an age of the IP addresses entry with a MAXAGE value read in during configuration;
removing the IP address entry from the stored IP address data if the entry's age is greater equal to MAXAGE;
one or more instructions for performing the following steps if it is determined that the IP address entry is currently blocked:
comparing the duration of the block is compared against the BLOCKTIME value read in during configuration; and
calling the external handler script to unblock the identified IP address entry and permit traffic from the address to flow through the network device if the duration is greater than or equal to BLOCKTIME.

30. The computer-readable medium of claim 19, further comprising
one or more instructions for storing a TIME value data in the stored IP address data representing the time that the IP address was added;
one or more instructions for storing a BTIME value data in the stored IP address data representing the time the address was blocked.
one or more instructions for determining the age of an IP address entry by subtracting the entry's TIME value from the current time of the check; and
one or more instructions for determining a block's duration by subtracting the entry's BTIME value from the current time of the check.
